(19) United States
(12) Patent Application Publication
(10) Pub. No.: US 2009/0157469 A1
(43) Pub. Date: Jun. 18, 2009

(54) System and Method for Management of Multi-Session, Sequential, Synchronized Electronic Conferencing

(76) Inventors: Jeffrey M. D'Urso, Randolph, MA (US); Michael D. Sachleben, Plainville, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 12/330,778

(22) Filed: Dec. 9, 2008

Related U.S. Application Data
(60) Provisional application No. 61/013,168, filed on Dec. 12, 2007.

(51) Int. Cl. G06Q 10/00

(52) U.S. Cl. 705/9

(57) ABSTRACT

A method, apparatus and computer program product for management of multi-session, sequential, synchronized electronic conferencing is presented. A schedule of meetings is defined for each of a plurality of users. Each user logs in to a website for taking part in the meetings according to the pre-defined or dynamically defined schedule. Each user also connects to a server (phone or video) for taking part in the meetings according to the schedule. Each user is placed into a holding area until a scheduled meeting is about to take place. A user is placed into a private conference room with at least one other user in accordance with the schedule of meetings, wherein each user can speak with another user in a same meeting and view details regarding the other user in the same meeting via the website.

### CROSS REFERENCE TO RELATED APPLICATIONS

The present application claims the benefit of U.S. Provisional Patent Application No. 61/013,168, filed on Dec. 12, 2007, which is incorporated herein by reference in its entirety.

### BACKGROUND

Studies in psychology have shown that people can make accurate decisions and/or judgments about other people within a matter of seconds of first meeting the person. When meeting someone else, people can often decide whether or not they want to continue pursuing the relationship (across all kinds of business or personal interactions) in a matter of minutes—yet existing customs, protocols, and methods do not allow them to take advantage of this potential efficiency.

For example, in the dating world, individuals who went on blind dates often knew in a matter of minutes that the date was not right for them—yet customs of good manners forced them to continue the date until its normal conclusion at the end of the night. In the business networking arena, participants who went to networking events hoping to make multiple contacts often find themselves “stuck” talking to one or two other participants, as breaking off contact might be considered rude or inappropriate. This often leads people feeling as if they did not use their time wisely to meet more potential prospects at a networking session. In both cases, hours can be wasted because there was no efficient or customary way to break away from a conversation or meeting.

“Speed Dating” was created to address the dating situation in the “offline world” (defined as normal human interaction with the world without the assistance of the Internet)—where it was possible to get all participants together in a room. In a typical Speed Dating scenario (see www.8minutedating.com for an example), single males and/or females show up in person at a specific location for an event. Each participant has the opportunity to go on five to ten minute “mini-dates”, where the participant sits across the table from a date for the allotted time of the mini-date. At the end of the allotted time one of the parties moves to another table, and a new mini-date with another person begins. In a single night, participants could quickly “vet” through five to ten dates (as opposed to one person on a traditional date) and then decide with whom they desire to follow up.

“Speed Networking” brought the efficiency of “Speed Dating” to the world of business networking—but like its inspiration, was limited to the offline world where participants could physically meet in the same location.

“Speed Interviewing” brought the same rapid-fire efficiency of mini-interviews to companies that were able to show up at a particular venue (physical location) and rapidly vet through multiple candidates to determine who they wanted to continue interviewing for potential hire. Speed dating, speed networking and speed interviewing are collectively referred to as speed meetings.

In all of these examples (speed dating, speed networking and speed interviewing), efficient processes have been developed to help participants rapidly hold “mini-meetings”—and therefore vet through several times as many potential candidates as through previous means; yet all of these prior solutions have required that the participants be available in a single physical location.

### SUMMARY

Conventional mechanisms such as those explained above suffer from a variety of deficiencies. One such deficiency is that there has been no easy way to coordinate such a speed meeting scenario via a computer and telephone. For example, in theory a company looking to run a Speed Interview could schedule candidates in six minute intervals and tell them to “look at the same screen” during each mini-interview, but real world constraints would make this cumbersome and nearly impossible to execute practically. For example, trying to get the candidate on the phone could eat up 30 seconds to 1 minute of time at best; and three minutes or more if the caller goes to voicemail. Further, there is no “universal time” in such a situation—e.g., if a candidate's clock is three minutes slow and the recruiter's clock is three minutes fast they will miss the entire session. Even if it were possible, scheduling such mini-interviews could very easily take more time to set up (because of phone-tag) than the entire interview block itself.

Embodiments of the invention significantly overcome such deficiencies and provide mechanisms and techniques that provide a solution for online Speed Meeting in a virtual world by providing each user a synchronized web & phone/video experience, enabling moderators to define meeting schedules (referred to herein as “Blitz Plans”) where users are placed into sequential web-conference meetings based on the plan, and managing data, notes, surveys and recordings made during the meetings created by the plan.

In a particular embodiment of a method for providing speed meetings, the method includes defining a schedule of meetings for each of a plurality of users. The method further includes enabling each user to login to a website for taking part in the meetings according to the schedule and enabling each user to connect to a server for taking part in the meetings according to the schedule. Additionally, the method includes placing each user in to a holding area until a scheduled meeting is about to take place and placing a user into a private conference room with at least one other user in accordance with the schedule of meetings, wherein each user can speak with another user in a same meeting and view details regarding the other user in the same meeting via the website.

Other embodiments include a computer readable medium having computer readable code thereon for providing speed meetings. The computer readable medium includes instructions for defining a schedule of meetings for each of a plurality of users. The computer readable medium further includes instructions for enabling each user to login to a website for taking part in the meetings according to the schedule and instructions for enabling each user to connect to a server for taking part in the meetings according to the schedule. Additionally, the computer readable medium includes instructions for placing each user in to a holding area until a scheduled meeting is about to take place and instructions for placing a user into a private conference room with at least one other user in accordance with the schedule of meetings—or a dynamic schedule determined during the call based on who is on the phone and specified matching preferences, wherein each user can speak with another user in a same meeting and view details regarding the other user in the same meeting via the website.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides speed meeting in a virtual world as explained herein that when performed (e.g. when executing) on the processor, operates as explained herein within the computerized device to perform all of the method embodiments and operations explained herein as embodiments of the invention. Thus any computerized device that performs or is programmed to perform processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing speed meeting in a virtual world as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. Note that each of the different features, techniques, configurations, etc. discussed in this disclosure can be executed independently or in combination. Accordingly, the present invention can be embodied and viewed in many different ways.

Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a speed meeting environment in accordance with embodiments of the invention;

FIG. 2 is an example screen shot of a moderator Graphical User Interface (GUI);

FIG. 3 is an example screen shot of a GUI for a user profile;

FIG. 4 is an example screen shot of a GUI for a scheduled blitz session;

FIG. 5 is an example screen shot of a GUI showing a schedule of blitz sessions;

FIG. 6 is an example screen shot of a GUI for a blitz plan;

FIG. 7 is a block diagram for a 1 :N blitz session;

FIG. 8 is a block diagram for an n:N blitz session;

FIG. 9 is a block diagram for a N:N blitz session;

FIG. 10 is a flow diagram of a method of producing an online Speed Meeting in a virtual world in accordance with embodiments of the invention; and

FIG. 11 illustrates an example computer system architecture for a computer system that performs speed meetings in a virtual world in accordance with embodiments of the invention.

### DETAILED DESCRIPTION

The present invention allows for speed meetings in a virtual world by providing the synchronization of all users' web and phone/video connection into a single, synchronized experience (referred to herein as a Blitz). In practice, this means that a user who is scheduled for a Blitz will log into a web site prior to the time at which they are scheduled be in a set of pre-planned or dynamically arranged meetings. The user also will dial into a phone session or initiate a video conference session with his or her pass code that has been provided to him or her on the web site (similar to dialing into a conference call bridge, except each user gets their own individual passcode). Once the person has logged into the web site and connected to the phone or video conferencing system, their web session and phone/video system will be managed together as a single experience per the Blitz Plan described below.

The invention manages the sequential initiation, management, and disconnecting of multiple users logged into the Blitz system in the above manner per the Blitz Plans described below.

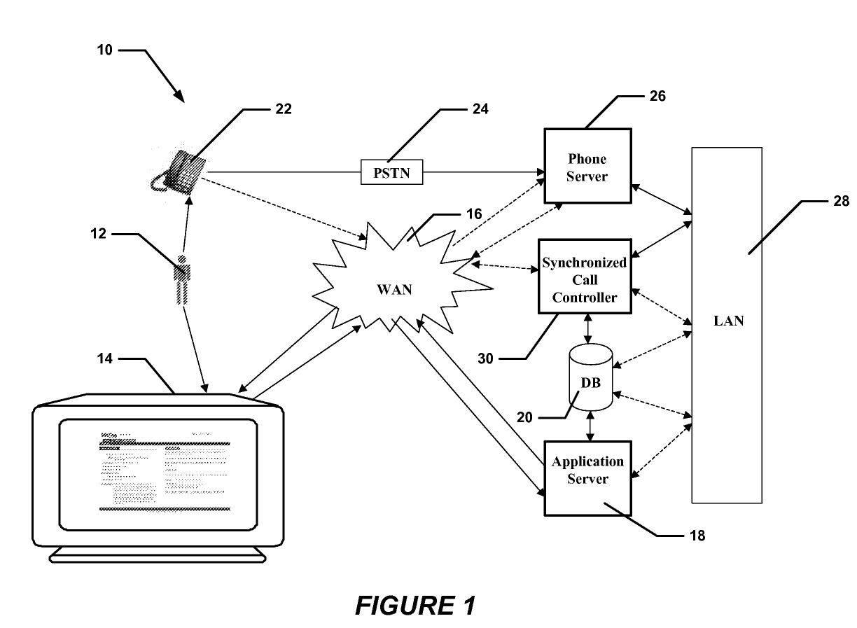

Referring now to FIG. 1, a block diagram of a system 10 for providing speed meetings in a virtual world is shown. A user 12 connects via a web browser 14 through a network 16 (e.g., Internet) to a Blitz application server 18. Blitz application server 18 is in communication with a database 20, either directly or via a Local Area Network (LAN) 28. A connection is thus established between the user's web browser 14 and the application server 18 through WAN 16.

With an established connection between the user's browser 14 and the application server 18, the application server 18 synchronizes the time shown on the user's browser 14 so that user sees “Server time”, upon which all plans are executed. When the user views “Server time”, it is converted to their local time zone for the user's convenience.

Conversion to server time is done as follows. First, the user's web browser 14 requests time. The server 18 responds with server timestamp (e.g., seconds since 1970) as well as time zone offset in seconds based on the user's time zone. Next, the user's browser 14 gets local time from user's computer (seconds since 1970), calculates an offset, and continues to track server time by using the client time changed by the offset. To keep the user and server further in synch, the server time and offset are recalculated periodically (e.g., every 30 seconds). This process of establishing a common “Server time” viewable in local time enables all users to be “on the same clock”. This also allows users to setup Blitzes (defined below), join Blitzes, etc. This is accomplished by enabling a user to login to application, and assigns them a phone number and code. The user 12 dials phone or video conference number given to them by web server

If conference call is a telephone conference call then user connection made to phone server 26 via the Public Switched Telephone Network (PSTN) 24 or via some VOIP protocol through Wide Area Network (WAN) 16. If conference call is a telephone conference call then phone server 26 connects to synchronized call controller (SCC) 30 via either Local Area Network 28 or WAN 16. If the conference call is a telephone conference call then SCC 30 connects to Database (DB) 20 via either a direct connection or via a LAN connection. SCC 30 enables Phone Server 26 to authenticate user 12 based on phone code.

Once the user 12 is authenticated, the SCC 30 controls user experience. SCC 30 places user 12 into phone or video holding area if they are not currently in a Blitz Session until their next scheduled Blitz Session begin. SCC 30 then places user 12 into a private conference room with the one or more other users scheduled for the same session. SCC 30 sets each user's web experience so their browser displays information about the current conversation as defined by the blitz session (e.g., in a “Speed Interview” scenario, both users see the same job requirement and user profile during the session). The SCC 30 also puts each user into phone or video holding area at end of each Blitz Session, where the user waits to be put into next scheduled Blitz Session, as determined by the Blitz Plan—or determined dynamically based on 1) who else is dialed into the event, 2) matching preferences specified by users prior to event (i.e., prefer to talk to person x/don't want to talk to person y), 3) who the user has already spoken to on the event. The SCC 30 will hang up on user after all sessions are completed for that user. Additionally, the SCC 30 optionally records each session (if applicable), and makes the recording available to the appropriate participant(s) from the application server 18 after the session. The SCC 30 also enables moderators to define “Blitz Plans” where users are scheduled to be placed into sequential web-conference meetings based on the plan (or dynamically based on predefined matching preferences).

The synchronized web/phone experience described above enables the system to deliver a variety of useful workflows to users. One workflow is referred to as a 1:N Blitz. A 1:N blitz allows a moderator to setup a “Blitz Plan” that allows the moderator (or their designated agent) to meet (e.g., interview) N participants during one or more defined blitz time slots.

During a 1:N Blitz, a single interviewer sequentially “blitzes” with multiple users (or candidates) based on a Blitz Plan defined by the moderator or interviewer ahead of time. A moderator/interviewer sets up a 1:N “Blitz Plan” prior to the blitz times.

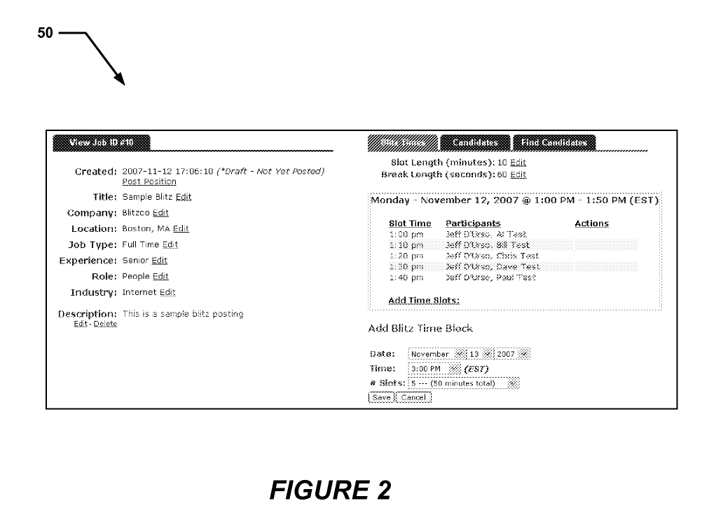

Referring to FIG. 2, an exemplary graphical user interface 50 that can be presented to the moderator for setting up a Blitz plan is shown. The Moderator/Interview posts Blitz announcement (“Job Requisition”) on a public website. The Moderator defines a length of each blitz slot (e.g., 10 minutes), and length of break between slots (e.g., 60 seconds at end of each slot). Each break is taken from the duration of the time defined within the Blitz slot. Moderator sets up “Blitz Time Slots” with assignable sessions for each block.

Once the Moderator defines blitz time slots (e.g., above); the Moderator can send a link to the blitz (i.e., job blitz requisition) via email or via a posting to any website. Candidates will follow the link or search for postings on the web site to apply to participate in the Blitz. Before applying for a slot within a Blitz, candidates must first create a profile on the web site, which is stored within the database. The blitz is scheduled such that the Moderator (in this example Jeff D'Urso) has a speed meeting with the first candidate (Al Test) at 1:00 p.m., followed by a speed meeting with Bill Test at 1:10 p.m., followed be a speed meeting with Chris Test at 1:20 p.m., followed by a speed meeting with Dave Test at 1:30 p.m. and followed by a final speed meeting with Paul Test at 1:40. Each meeting will last for a total of nine minutes (the ten minute slot minus the sixty second break), and over the course of less than one hour, the Moderator has met with five candidates.

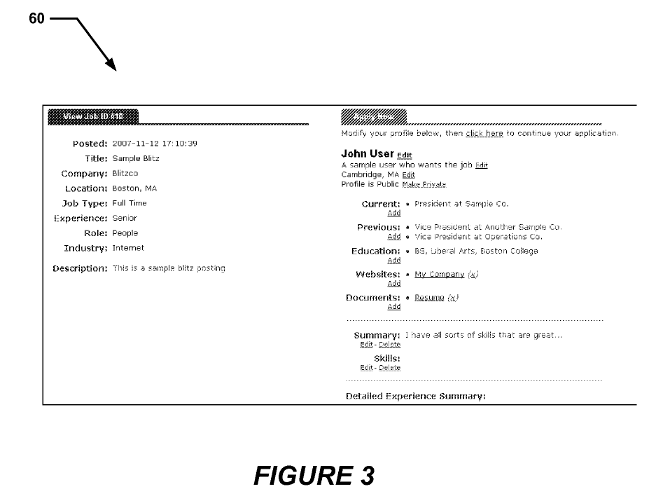

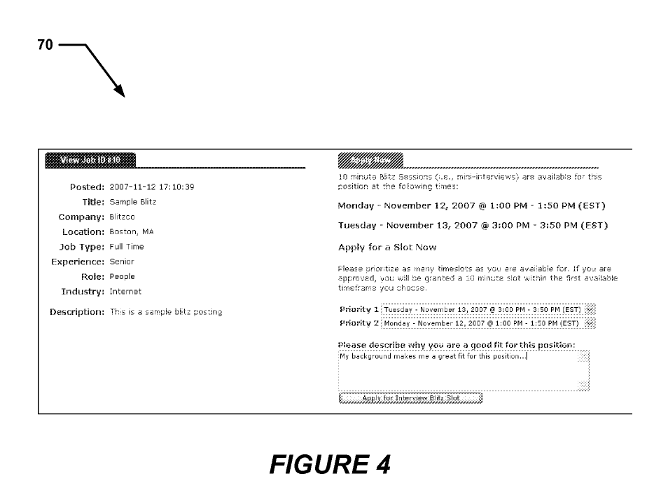

FIG. 3 shows an exemplary GUI 60 that can be sent to each candidate (e.g., in the form of a web page) to be used for creating such a profile. Once a candidates (in this example John User) has entered a profile or logged into the web site using a user name and password already connected to a profile, they then continue by applying for the specific job/requesting a blitz slot, and specifying which time slots are best for them as below. This can de done using the exemplary web page (or other GUI) 70 shown in FIG. 4.

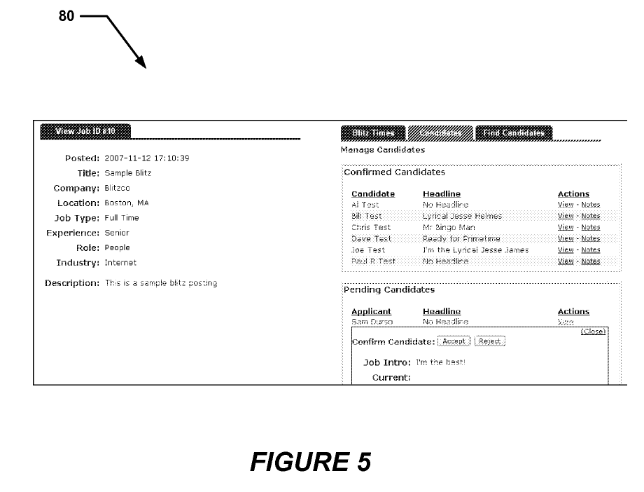

Referring now to FIG. 4, the moderator/interviewer can then accept/decline applications—and the application will assign each candidate a slot based on their specified priority. This can be done using a Web page (or other GUI) presented to the moderator such as the web page 80 shown in FIG. 5. FIG. 5 shows the confirmed candidates, as well as a potential candidate (Sam Durso). The Moderator has the option of either accepting the pending candidate or rejecting the pending candidate.

Once candidates have been accepted into blitz slots, the “Blitz Plan” is now ready to be executed. Candidates are notified of the time at which they are to connect to the Blitz server.

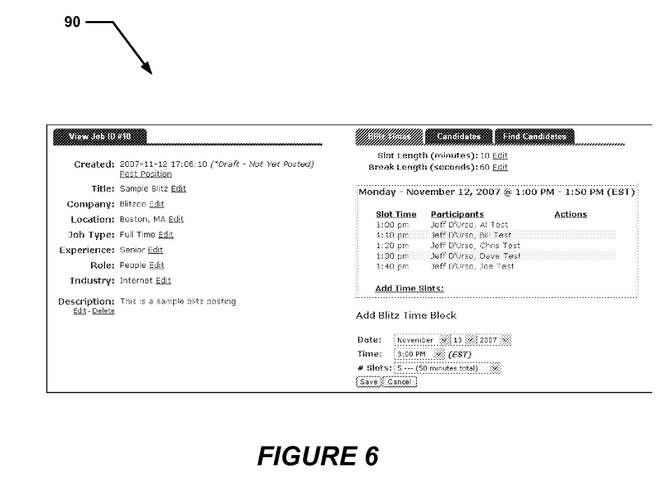

FIG. 6 shows a GUI 90 displaying what type of data moderators will see when they review their properly set-up Blitz Plans. The blitz is scheduled such that the Moderator (in this example Jeff D'Urso) has a speed meeting with the first candidate (Al Test) at 1:00 p.m., followed by a speed meeting with Bill Test at 1:10 p.m., followed be a speed meeting with Chris Test at 1:20 p.m., followed by a speed meeting with Dave Test at 1:30 p.m. and followed by a final speed meeting with Paul Test at 1:40. Each meeting will last for a total of nine minutes (the ten minute slot minus the sixty second break), and over the course of less than one hour, the Moderator has met with five candidates. Referring back to FIG. 5, pending candidate Sam Durso was not accepted to be part of the blitz session, and Joe Test was removed from the confirmed candidates list.

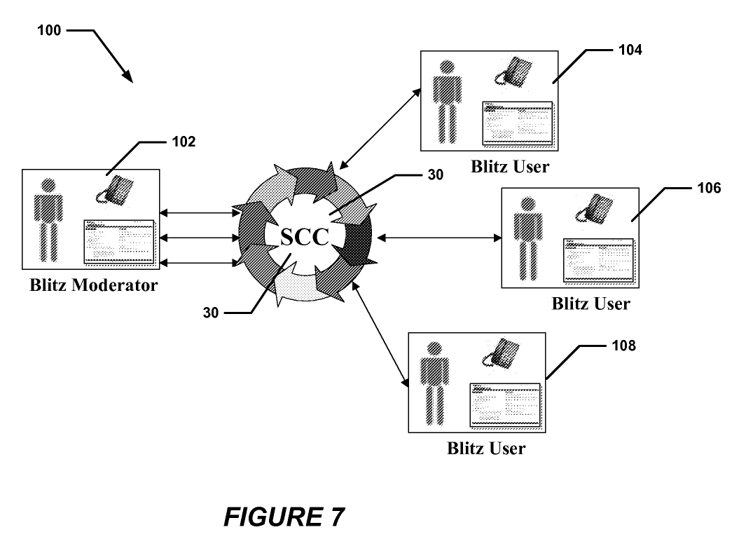

Once the Blitz Plan is defined as per above, and users have logged into the system (web and phone or video as described above), the blitz is ready to be executed. The Moderator and users connect to website and login to phone server (as described above 1). Prior to the sessions, all users are on hold on the phone server. Then as the blitz begins, the following takes place, as shown in the blitz environment 100 in FIG. 7.

When the first timeslot begins, the moderator 102 and a first user 104 are both placed into a private phone or video conference meeting room. At the same time, they are placed into a private web conference. Both users will be taken to a web page that shows the job requirement (or other 1:N blitz description), as well as the user's profile (i.e., resume/application for the job). As the moderator 102 and user 104 talk, each will see a countdown timer showing how long is left in the session. As the session is almost over, the system will indicate this to both the moderator 102 and user 104 via visual cues (e.g., flashing signals on the website) and/or audio cues (beeping in the conference room).

During the session, both the moderator 102 and user 104 will be given a chance to enter notes and ratings that they can each review later. Once the session is over, both the moderator 102 and user 1041 will be placed on hold. Both parties will be allowed to make an audio recording that describes in detail notes or other messages pertinent to the previous conversation. For example, an interviewer can dictate audio notes about the interview afterwards that they can play later to remind them about the conversation they had with the candidate. For example, a candidate can record a thank you/clarification message that will go to the interviewer after the call. The amount of time that the moderator 102 may use to leave notes is not greater than the amount of time that was set as a “break” between Blitz sessions in the Blitz Plan. Both parties will also have the ability to answer survey questions about their conversation. For example, interviewer can answer survey questions and ratings that will be stored to enable them to rank candidates later. For example, interviewer or candidate can answer survey questions and ratings that will be used to 1) give feedback to the company to improve service, and 2) establish a “feedback rating” for companies (i.e., who gets good reviews as opposed to poor reviews, and reviews in between good and poor).

The recording of the session (if requested previously by the moderator 102) will be stored for later retrieval by the moderator 102 and his agent(s). The moderator's notes will be stored with the Blitz Session, and can be viewed later by the moderator 102 and other parties invited by the moderator (e.g., co-workers). The moderator 102 is placed on hold for the break time (specified previously as described above).

When the second timeslot begins, the moderator 102 and user 106 are both placed into a private phone conference meeting room. At the same time they are placed into a private web conference. Both users will be taken to a web page that shows the job requirement (or other 1:N blitz description), as well as the user's profile (i.e., resume application for the job). The same web and phone experience that occurred between moderator 102 and user 104 now occurs between moderator 102 and user 106. The Moderator continues to “blitz” with users (e.g. user 108 etc.) until there are no longer timeslots left in the Blitz according to the Blitz Plan.

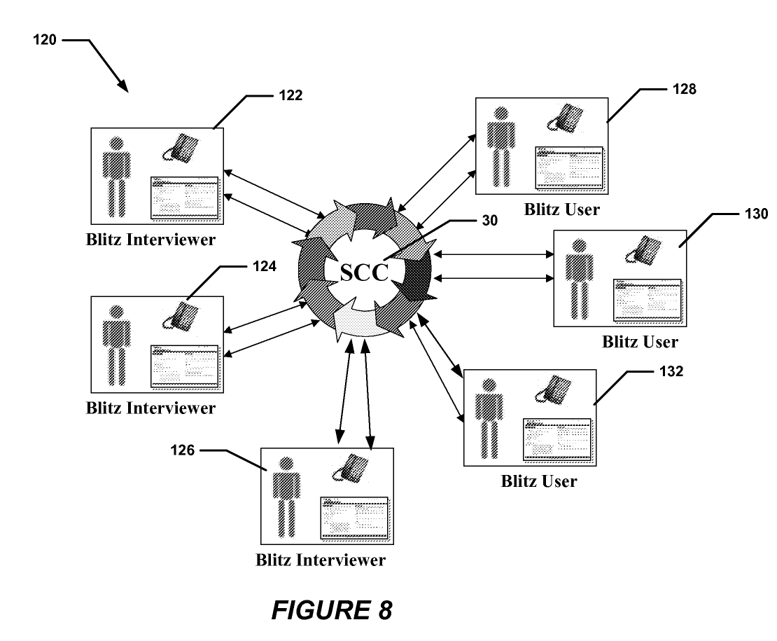

Another workflow is referred to as a n:N Blitz, as shown in environment 120 of FIG. 8. An n:N Blitz works the same way as a 1:N blitz, except there are multiple moderators or “interviewers” who each have a chance to blitz with all of the candidate users during the Blitz. The setup of a n:N blitz is similar to the setup described above for the 1:N Blitz, except that there are multiple interviewers specified, and each user is given a slot with each of the interviewers.

All Moderators (e.g., interviewers 122, 124 through 126) and users (e.g., users 128, 130 through 132) connect to website and login to phone or video server (as described in section 1). Prior to the sessions, all users are on hold on the phone or video server. Then as the blitz begins the following takes place.

When the first timeslot begins, interviewer 122 and user 128 are both placed into a private phone or video conference meeting room. At the same time, they are placed into a private web room with same experience as detailed in 1:N above. At the same time, interviewer 124 and user 130 are both placed into a private phone or video conference meeting room and web room (which is different than the one entered into by interviewer 122 and user 1281). These people have the same experience as detailed in the discussion of the 1:N Blitz session described above. Further, at the same time, interviewers 126 et al. are each paired into private web/phone or video conference rooms with users 132 et al. and have same experience as the discussion of the 1:N Blitz session described above.

At beginning of the second timeslot and for each timeslot thereafter, each interviewer 122, 124 through 126) is paired with a new user (as above) until, at the end of the Blitz, each interviewer has had a chance to speak with each user.

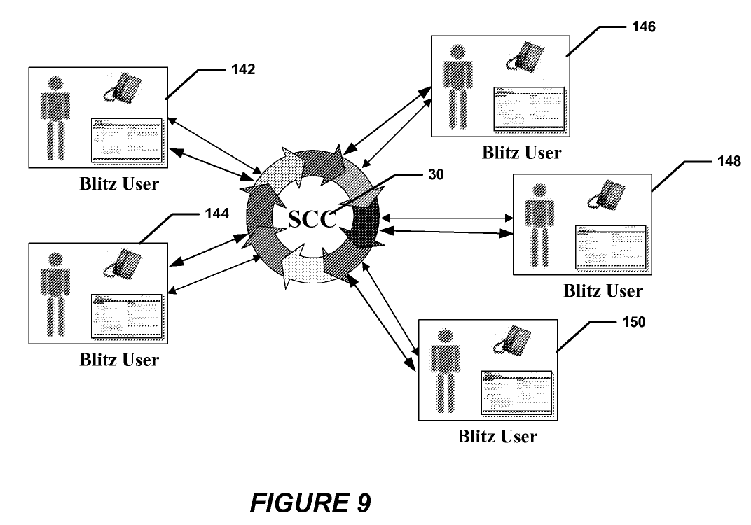

Another workflow is referred to as a N:N Mix Blitz, as shown in environment 140 of FIG. 9. In a N:N “Mix Blitz”, users are simultaneously paired into multiple sequential 1-on-1 blitz sessions until they have had a chance to talk to some, many, or all of the other participants in the blitz.

During setup of a N:N blitz, a moderator specifies the description of the blitz, and schedules a time for the blitz. The moderator then specifies a length of each session, a length of each break (similar to 1:N blitz)—or a system defined default break length (e.g., 30 seconds), a total number of session timeslots (i.e., a maximum number of conversations), and a number of simultaneous sessions. The moderator can also specify conference sessions during the event (e.g., a pre-blitz conference and a post-blitz conference). These conference sessions place all users into the same conference room much like a standard conference bridge. After setup, they invite users to join the blitz, and those users are placed into a Blitz Plan so they each have multiple blitz sessions with other users in the blitz. Those users can also specify matching preferences before the event (e.g., I'd prefer to talk to person X, I don't want to talk with person Y).

During execution of an N:N event, users login to the web application and dial-in to the phone line and login there via their passcode immediately prior to the event start. If they dial in before the event start, they are placed on hold. At the event start, if a pre-conference is scheduled, then all users are placed into the same “conference room” and kept there during the length of the pre-conference. Once the pre-conference has ended, then the “speed networking” begins.

During a typical N:N event, “Blitz Plans” are built dynamically from session to session based not just on who has signed up for the event, but who has actually dialed/logged in to the event. At some point before the start of each session (e.g., immediately prior, one minute prior, or some other time prior to the session), the application SCC determines who should be matched with whom for the next session. To create this matching plan for the next session, the SCC 1) starts with the list of participants who are dialed in/connected now (e.g., if someone failed to show for the event, they are not included). 2) Then the SCC factors in user preferences (e.g., I'd like to talk with person X, I don't want to talk with person Y), and it builds a conversation plan for the next session (e.g., John Smith to talk with Jim Bishop; Mary Jones to talk with Al Test, etc). If the SCC can't match someone for a session, it gives him or her a “bye” session, then gives him or her preferential matching treatment for subsequent sessions during the event.

After the Blitz Plan is defined for a session, and the session time starts—each user is put into the appropriate meeting room based on the calculated plan for that session. Each meeting room will have two or more participants, with the users each seeing the other user's information on the web interface.

During the break time between each session/conversation, the application will either play hold music or a pre-recorded message (e.g., advertisement, promotional message, service announcement, etc) into the break. During this break, if a special message is being played on the user's phone, then the web interface may also show a related visual ad/advertiser link.

Once the “speed networking” has ended (because the maximum number of requested conversations has happened, or everyone has spoken to everyone else), then the SCC will place users into a post-conference if that was defined in the Blitz Plan. In that case, all users are placed into the same conference room for this session (similar to the pre-conference session).

Beyond conference sessions and matched speed networking sessions, a Blitz Plan can also include a “feedback session” which plays a pre-recorded message (recorded by the moderator or application default), then allows each event participant a chance to give audio feedback, which is then available to the moderator at the end of the event.

Since the goal of many blitzes is to help people vet potential business or personal relationships, the application provides mechanisms to access data captured during a blitz after the blitz is over. These include an audio recording of the blitz session, if applicable. E.g., interviewer can review the audio recording of each candidate interviewed during a blitz and share the audio recordings with other people as the interviewer sees fit. There may also be a video recording of the blitz session, if applicable. E.g., an interviewer can review the video recording of each candidate interviewed during a blitz and share the video recordings with other people as the interviewer sees fit.

Notes and surveys can be taken as well as ratings made of the interviewers feelings about other person during the blitz session. The interviewer can take notes during the session with the candidate, fill out a survey about the candidate and also give the candidate a rating in various pre-determined areas. After the session, the interviewer can finish adding notes during the break. The interviewer can also add/edit notes after the blitz. Audio notes can be captured during the break. An interviewer can talk with a candidate for a nine minute blitz session and then during the one minute break record their own audio notes about the candidate for later review by them and their colleagues. An audio thank you from candidate can be captured during break or after the conversation with the interviewer has been completed.

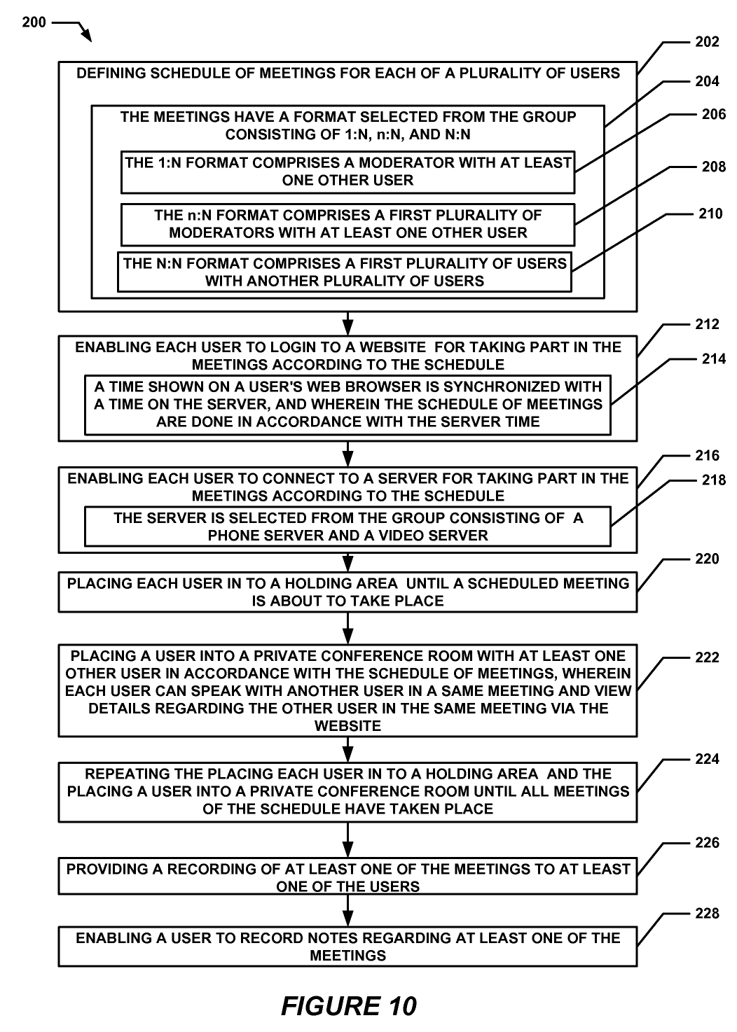

A flow chart of a particular embodiment of the presently disclosed method is depicted in FIG. 10. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 10, a particular embodiment of a method for management of a multi-session, sequential, synchronized electronic conferencing session 200 is shown. Method 200 begins with processing block 202 which discloses defining a schedule of meetings for each of a plurality of users. The schedule may be pre-defined or may be dynamically determined based on who is in attendance for the sessions and user-specified preferences. Each meeting has a predetermined time limit, and there is a break before a next meeting begins. As shown in processing block 204 the meeting have a format selected from the group consisting of 1:N, n:N, and N:N. Processing block 206 shows that a 1:N format comprises a moderator with at least one other user. An example use of this type of format is for an interview wherein a single person interviews multiple candidates. Processing block 208 depicts that an n:N format comprises a first plurality of moderators with at least one other user. An example use of this type of format is for an interview wherein multiple persons interview multiple candidates. Processing block 210 shows that an N:N format comprises a first plurality of users with another plurality of users. An example use of this type of format is for a networking event wherein multiple persons can meet with multiple others.

Processing block 212 states enabling each user to login to a website for taking part in the meetings according to the schedule or dynamically calculated Blitz Plan (per N:N description above). As shown in processing block 214, a time shown on a user's web browser is synchronized with a time on the server, and wherein the schedule of meetings are done in accordance with the server time.

Processing continues with processing block 216 which discloses enabling each user to connect to a server for taking part in the meetings according to the schedule. As shown in processing block 218 the server is selected from the group consisting of a phone server and a video server. The person can participate in the blitz via a telephone or via a video conference.

Processing block 220 states placing each user into a holding area until a scheduled meeting is about to take place. Processing block 222 discloses placing a user into a private conference room with at least one other user in accordance with the schedule of meetings, wherein each user can speak with another user in a same meeting and view details regarding the other user in the same meeting via the website.

Processing block 224 states repeating the placing each user in to a holding area and the placing a user into a private conference room until all meetings of the schedule (pre-determined or dynamically calculated per N:N description above) have taken place. Processing block 226 recites providing a recording of at least one of the meetings to at least one of the users, and processing block 228 states enabling a user to record notes regarding at least one of the meetings.

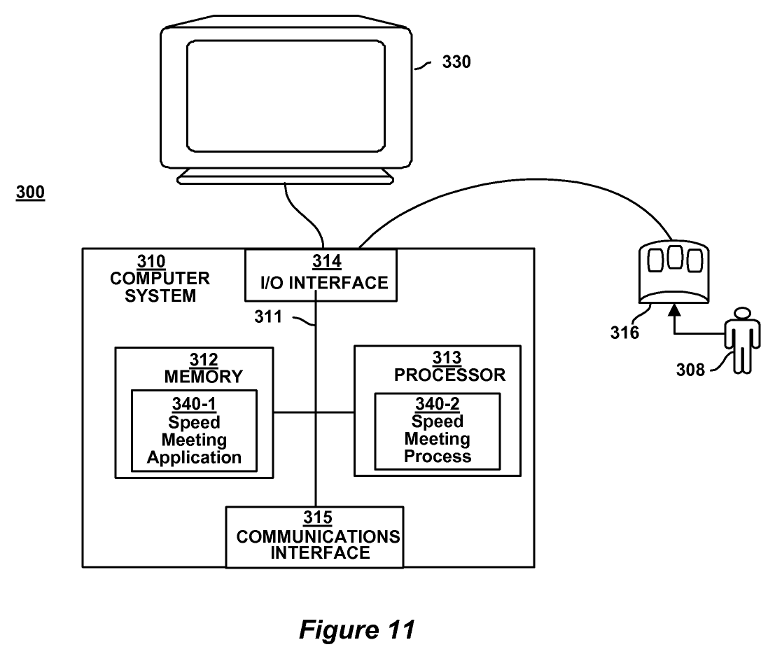

Referring now to FIG. 11, is a block diagram illustrating example architecture of a computer system 310 that executes, runs, interprets, operates or otherwise performs a speed meeting application 340-1 and speed meeting process 340-2 suitable for use in explaining example configurations disclosed herein. The computer system 310 may be any type of computerized device such as a personal computer, workstation, portable computing device, console, laptop, network terminal or the like. An input device 316 (e.g., one or more customer/developer controlled devices such as a keyboard, mouse, etc.) couples to processor 313 through I/O interface 314, and enables a customer 308 to provide input commands, and generally control the graphical customer interface 360 that the speed meeting application 340-1 and process 340-2 provides on the display 330. Essentially, the graphical user interface 360 is where the customer 308-1 performs their ‘online banking’, specifying which bills are to be paid electronically, when those bills are to be paid, and the amount to be paid. As shown in this example, the computer system 310 includes an interconnection mechanism 311 such as a data bus or other circuitry that couples a memory system 312, a processor 313, an input/output interface 314, and a communications interface 315. The communications interface 315 enables the computer system 310 to communicate with other devices (i.e., other computers) on a network (not shown).

The memory system 312 is any type of computer readable medium, and in this example, is encoded with a speed meeting application 340-1 as explained herein. The speed meeting application 340-1 may be embodied as software code such as data and/or logic instructions (e.g., code stored in the memory or on another computer readable medium such as a removable disk) that supports processing functionality according to different embodiments described herein. During operation of the computer system 310, the processor 313 accesses the memory system 312 via the interconnect 311 in order to launch, run, execute, interpret or otherwise perform the logic instructions of a speed meeting application 340-1. Execution of a speed meeting application 340-1 in this manner produces processing functionality in the speed meeting process 340-2. In other words, the speed meeting process 340-2 represents one or more portions or runtime instances of a speed meeting application 340-1 (or the entire a speed meeting application 340-1) performing or executing within or upon the processor 313 in the computerized device 310 at runtime.

It is noted that example configurations disclosed herein include the speed meeting application 340-1 itself (i.e., in the form of un-executed or non-performing logic instructions and/or data). The speed meeting application 340-1 may be stored on a computer readable medium (such as a floppy disk), hard disk, electronic, magnetic, optical, or other computer readable medium. A speed meeting application 340-1 may also be stored in a memory system 312 such as in firmware, read only memory (ROM), or, as in this example, as executable code in, for example, Random Access Memory (RAM). In addition to these embodiments, it should also be noted that other embodiments herein include the execution of a speed meeting application 340-1 in the processor 313 as the speed meeting process 340-2. Those skilled in the art will understand that the computer system 310 may include other processes and/or software and hardware components, such as an operating system not shown in this example.

A display 330 need not be coupled directly to computer system 310. For example, the speed meeting application 340-1 can be executed on a remotely accessible computerized device via the network interface 315. In this instance, the graphical customer interface 360 may be displayed locally to a customer 308 of the remote computer, and execution of the processing herein may be client-server based.

During operation, processor 313 of computer system 300 accesses memory system 312 via the interconnect 311 in order to launch, run, execute, interpret or otherwise perform the logic instructions of the persistent security application 340-1. Execution of persistent security application 340-1 produces processing functionality in persistent security process 340-2. In other words, the persistent security process 340-2 represents one or more portions of the persistent security application 340-1 (or the entire application) performing within or upon the processor 313 in the computer system 300.

It should be noted that, in addition to the persistent security process 340-2, embodiments herein include the persistent security application 340-1 itself (i.e., the un-executed or non-performing logic instructions and/or data). The persistent security application 340-1 can be stored on a computer readable medium such as a floppy disk, hard disk, or optical medium. The persistent security application 340-1 can also be stored in a memory type system such as in firmware, read only memory (ROM), or, as in this example, as executable code within the memory system 312 (e.g., within Random Access Memory or RAM).

In addition to these embodiments, it should also be noted that other embodiments herein include the execution of persistent security application 340-1 in processor 313 as the persistent security process 340-2. Those skilled in the art will understand that the computer system 300 can include other processes and/or software and hardware components, such as an operating system that controls allocation and use of hardware resources associated with the computer system 300.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the Internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A computer-implemented method in which a computer system performs operations comprising:
defining a schedule of meetings for each of a plurality of users;
enabling each user to login to a website for taking part in said meetings according to said schedule;
enabling each user to connect to a server for taking part in said meetings according to said schedule;
placing each user in to a holding area until a scheduled meeting is about to take place; and
placing a user into a private conference room with at least one other user in accordance with said schedule of meetings, wherein each user can speak with another user in a same meeting and view details regarding said other user in the same meeting via the website.

2. The method of claim 1 further comprising repeating said placing each user in to a holding area and said placing a user into a private conference room until all meetings of said schedule have taken place.

3. The method of claim 1 wherein said meetings have a format selected from the group consisting of 1:N, n:N, and N:N.

4. The method of claim 3 wherein said 1:N format comprises a moderator with at least one other user.

5. The method of claim 3 wherein said n:N format comprises a plurality of moderators with at least one other user.

6. The method of claim 3 wherein said N:N format comprises a first plurality of users with another plurality of users.

7. The method of claim 1 further comprising providing a recording of at least one of said meetings to at least one of said users.

8. The method of claim 1 further comprising enabling a user to record notes regarding at least one of said meetings.

9. The method of claim 1 wherein a time shown on a user's web browser is synchronized with a time on said server, and wherein said schedule of meetings are done in accordance with said time on said server.

10. The method of claim 1 wherein said server is selected from the group consisting of a phone server and a video server.

11. The method of claim 1 wherein said schedule comprises a dynamic schedule determined during the call based on at least one of the group consisting of who is on the phone and specified matching preferences.

12. A computer readable storage medium having computer readable code thereon for management of multi-session, sequential, synchronized electronic conferencing, the medium including instructions in which a computer system performs operations comprising:
defining a schedule of meetings for each of a plurality of users;
enabling each user to login to a website for taking part in said meetings according to said schedule;
enabling each user to connect to a server for taking part in said meetings according to said schedule;
placing each user in to a holding area until a scheduled meeting is about to take place; and
placing a user into a private conference room with at least one other user in accordance with said schedule of meetings, wherein each user can speak with another user in a same meeting and view details regarding said other user in the same meeting via the website.

13. The computer readable storage medium of claim 12 further comprising repeating said placing each user in to a holding area and said placing a user into a private conference room until all meetings of said schedule have taken place.

14. The computer readable storage medium of claim 12 wherein said meetings have a format selected from the group consisting of 1:N, n:N, and N:N.

15. The computer readable storage medium of claim 14 wherein said 1:N format comprises a moderator with at least one other user.

16. The computer readable storage medium of claim 14 wherein said n:N format comprises a plurality of moderators with at least one other user.

17. The computer readable storage medium of claim 14 wherein said N:N format comprises a first plurality of users with another plurality of users.

18. The computer readable storage medium of claim 12 further comprising providing a recording of at least one of said meetings to at least one of said users.

19. The computer readable storage medium of claim 12 further comprising enabling a user to record notes regarding at least one of said meetings.

20. The computer readable storage medium of claim 12 wherein a time shown on a user's web browser is synchronized with a time on said server, and wherein said schedule of meetings are done in accordance with said time on said server.

21. The computer readable storage medium of claim 12 wherein said server is selected from the group consisting of a phone server and a video server.

22. The computer readable storage medium of claim 12 further comprising instructions wherein said schedule comprises a dynamic schedule determined during the call based on at least one of the group consisting of who is on the phone and specified matching preferences.

23. A computer system comprising:
a memory;
a processor;
a communications interface;
an interconnection mechanism coupling the memory, the processor and the communications interface; and
wherein the memory is encoded with an application providing management of multi-session, sequential, synchronized electronic conferencing, that when performed on the processor, provides a process for processing information, the process causing the computer system to perform the operations of:
defining a schedule of meetings for each of a plurality of users;
enabling each user to login to a website for taking part in said meetings according to said schedule;
enabling each user to connect to a server for taking part in said meetings according to said schedule;
placing each user in to a holding area until a scheduled meeting is about to take place; and
placing a user into a private conference room with at least one other user in accordance with said schedule of meetings, wherein each user can speak with another user in a same meeting and view details regarding said other user in the same meeting via the website.
